(19) United States
(12) Patent Application Publication
(10) Pub. No.: US 2024/0147169 A1
(43) Pub. Date: May 2, 2024

(54) A HEARING AID SYSTEM AND A METHOD OF OPERATING A HEARING AID SYSTEM

(71) Applicant: WIDEX A/S, Lynge (DK)

(72) Inventors: Alan WIINBERG, Lynge (DK); Johan Myhre ANDERSEN, Lynge (DK); Ole HAU, Lynge (DK); SKatja FREELS, Lynge (DK)

(73) Assignee: WIDEX A/S, Lynge (DK)

(21) Appl. No.: 18/279,967

(22) PCT Filed: Feb. 9, 2022
(86) PCT No.: PCT/EP2022/053117

§ 371 Date: Sep. 1, 2023

(30) Foreign Application Priority Data
Mar. 5, 2021 (DK) PA202100227

(51) Int. Cl. H04R 25/00

(52) U.S. Cl. CPC H04R 25/453; H04R 2430/01

(57) ABSTRACT

A hearing aid system (200) with improved adaptive feedback suppression based on de-correlation and a method (300) of operating such a hearing aid system.

### 1 FIELD OF THE INVENTION

The present invention relates to hearing aid systems. The invention more particularly relates to hearing aid systems that rely on adaptive feedback cancellation in order to reduce the problems caused by acoustic feedback. The invention also relates to methods of operating hearing aid systems.

### 2 BACKGROUND OF THE INVENTION

Within the context of the present disclosure a hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor adapted to provide amplification in those parts of the audible frequency range where the user suffers a hearing deficit, and an acoustic output transducer. The signal processor is preferably a digital signal processor. The hearing aid is enclosed in a casing suitable for fitting behind or in a human ear.

Within the present context a hearing aid system may comprise a single hearing aid (a so called monaural hearing aid system) or comprise two hearing aids, one for each ear of the hearing aid user (a so called binaural hearing aid system). Furthermore, the hearing aid system may comprise an external device, such as a smart phone having software applications adapted to interact with other devices of the hearing aid system. Thus within the present context the term “hearing aid system device” may denote a hearing aid or an external device.

Generally a hearing aid system according to the invention is understood as meaning any system which provides an output signal that can be perceived as an acoustic signal by a user or contributes to providing such an output signal and which has means which are used to compensate for an individual hearing loss of the user or contribute to compensating for the hearing loss of the user. These systems may comprise hearing aids which can be worn on the body or on the head, in particular on or in the ear, and can be fully or partially implanted. However, some devices whose main aim is not to compensate for a hearing loss may nevertheless be considered a hearing aid system, for example consumer electronic devices (such as headsets) provided they have some measures for at least partly alleviating an individual hearing loss.

Acoustic feedback from a receiver to one or more microphones will limit the maximum amplification that can be applied in a hearing aid. Due to the feedback, the amplification in the hearing aid can cause resonances, which shape the spectrum of the output of the hearing aid in undesired ways and even worse, it can cause the hearing aid to become unstable, resulting in whistling or howling. The hearing aid usually employs compression to compensate hearing loss; that is, the amplification gain is reduced with increasing sound pressures. Moreover, an automatic gain control is commonly used on the output to limit the output level, thereby avoiding clipping of the signal. In case of instability, these compression effects will eventually make the system marginally stable, thus producing a howl or whistle of nearly constant sound level.

Feedback suppression is often used in hearing aids to compensate the acoustic feedback. The acoustic feedback path can change dramatically over time as a consequence of, for example, amount of earwax, the user wearing a hat or holding a telephone to the ear or the user is chewing or yawning. For this reason, it is customary to apply an adaptation mechanism on the feedback suppression to account for the time-variations.

One widely used method for feedback suppression in hearing aid systems is based on adaptive feedback cancellation. Reference is therefore first given to FIG. 1 which illustrates highly schematically a hearing aid 100, according to the prior art, comprising means for adaptive feedback cancellation.

The hearing aid 100 comprises at least one acoustical-electrical input transducer 101 providing an input signal 106 (which in the following may also be denoted microphone signal y(n)), a digital signal processor 102 (which in the following may also be denoted hearing aid processor) providing an output signal 111 (which in the following may also be denoted loudspeaker signal u(n)), an electrical-acoustical output transducer 103, an adaptive feedback filter 104 and an adaptive feedback estimator 105.

Acoustic feedback occurs when part of the loudspeaker signal is picked up by a microphone creating an acoustic closed loop. A closed loop system becomes unstable when a magnitude of a signal traveling around the loop does not decrease for each round trip, and the feedback signal adds up in phase with a microphone signal. Hence, feedback limits the maximum stable gain achievable, it deteriorates the sound quality by producing a distortion of an incoming signal and can cause howling when the system becomes unstable.

Feedback problems can be reduced by adaptive feedback cancellation techniques that attempt to model a feedback path response h(n) using the adaptive feedback estimator 105 and the adaptive feedback filter 104 and subtract a modeled feedback signal \hat{v}(n) (which in the following may be denoted feedback cancellation signal 109) provided by the adaptive feedback filter 104 from the microphone signal 106 (y(n)).

In FIG. 1, the adaptive feedback filter 104 provides an estimate ĥ(n) of the true acoustic feedback path response h(n). Ideally, ĥ(n)=h(n) and the feedback cancellation signal 109 (\hat{v}(n)) will hereby be identical to the true feedback signal 108 (v(n)). This implies that a residual signal 110 (e(n)) after subtraction of the feedback cancellation signal 109 (\hat{v}(n)) from the microphone signal 106 (y(n)) will only contain the incoming signal 107 (x(n)) without feedback, i.e. e(n)=x(n).

However, a general issue with adaptive feedback cancellation methods for acoustic feedback suppression is that the adaptation generally will not converge towards the optimum suppression of the acoustic feedback due to the biased estimation of ĥ(n).

It can be shown that the bias is given by a cross correlation vector E [u(n)x(n)] between the output signal 111 (u(n)) and the incoming signal 107 (x(n)). Hence, correlation between the output signal 111 and the incoming signal 107 biases the estimation of h(n), and thereby leads to a reduced feedback cancellation performance and may cause the cancellation system to fail and howling to occur.

For most audio signals, the correlation, between the incoming signal 107 and the output signal 111, is strong for short hearing aid signal processing delays and becomes weaker with increasing hearing aid signal processing delays.

Different techniques have been proposed to reduce the biased estimation problem.

One known technique applies de-correlation (e.g. pre-whitening techniques) in the adaptive estimation path. Generally, the advantage of carrying out the decorrelation in the adaptive estimation path is that this does not modify the receiver signal, such that no sound quality degradation is introduced due to the decorrelation. However, this is often not sufficient to ensure a good and reliable canceler performance. This is especially the case when the incoming signal is tonal and hence highly correlated or when the hearing aid processing delay is low.

Alternatively (or additionally) the canceling performance can be improved by de-correlating the loudspeaker signal 111 relative to the incoming signal 107, e.g. by means of frequency shifting or phase shifting. However, this comes at the price of added delay to the main signal path and audible artifacts caused especially by the interference between directly transmitted sound (i.e. ambient sound transmitted past the hearing aid and towards the ear drum) and the amplified and frequency shifted sound provided by the hearing aid.

EP-B1-2736271 discloses an audio processing device comprising a de-correlation unit and an audibility sensor. The de-correlation unit may be configured to introduce a frequency shift in a signal of the forward path and the audibility sensor may be configured to estimate whether or not a given artefact is audible based on a correlation detection unit for determining a) the auto-correlation of a signal of the forward path and/or b) the cross-correlation between two different signals of the forward path.

The present invention differs from above mentioned EP-B1-2736271 at least in that the present invention is directed at avoiding audible artefacts in the form of beating noise (which in following may also be denoted amplitude modulation) that results from mixing (in the ear canal) of the directly transmitted sound (e.g. mainly through the vent) with a frequency shifted sound provided by the hearing aid as further discussed in the following sections.

Thus, there is still a need to improve the performance of feedback cancellation systems based on frequency shifting especially with respect to avoiding audible artefacts.

It is therefore a feature of the present invention to provide a hearing aid system with improved adaptive feedback cancellation while maintaining high sound quality.

It is another feature of the present invention to provide a method of operating a hearing aid system that provides improved feedback cancellation while maintaining high sound quality.

### 3 SUMMARY OF THE INVENTION

A hearing aid system according to a first aspect of the invention comprises an acoustical-electrical input transducer configured to receive an audio input signal and to output an input transducer output signal, a first combiner, configured to subtract a feedback cancellation signal from the input transducer output signal and to hereby generate a residual signal, a digital signal processor configured to process the residual signal to generate a processed residual signal, an electrical-acoustical output transducer configured to receive an output transducer input signal and to generate an acoustical output transducer output signal, an adaptive feedback canceller configured to receive the residual signal and the output transducer input signal and to provide the feedback cancellation signal; a de-correlation unit configured to, when active, receive the processed residual signal and to frequency shift at least part of the processed residual signal and hereby provide a frequency shifted output transducer input signal, an artifact detector configured to determine if active operation of the de-correlation unit, in a current sound environment, will result in audible artifacts in the form of amplitude modulation due to mixing in the ear canal of a directly transmitted sound and the frequency shifted acoustical output transducer output signal, and a de-correlation controller configured to activate or de-activate the de-correlation unit dependent on whether the artifact detector determines that active operation of the de-correlation unit will result in audible artifacts.

The hearing aid system according to the invention can provide good feedback cancellation performance while significantly reducing the sound quality degradation associated with frequency shifting.

According to an embodiment, the artifact detector further comprises a band pass filter bank configured to band pass filter the input transducer output signal into at least one band pass filtered frequency band signal.

In a preferred embodiment, the artifact detector comprises at least one envelope extractor configured to receive the input transducer output signal or said at least one band pass filtered frequency band signal and configured to provide a respective temporal envelope for the input transducer output signal or for each of said at least one band pass filtered frequency band signals and hereby providing at least one envelope signal.

The artifact detector, in a further aspect, comprises at least one envelope filter bank comprising at least two envelope band pass filters wherein each of said at least one envelope filter banks are configured to receive an envelope signal and to provide a plurality of band pass filtered envelope signals.

According to a further embodiment, at least one of said (at least one) envelope filter banks comprises at least two different envelope band pass filters each configured to provide a band pass filtered envelope signal within a frequency range below 32 Hz or below 100 Hz.

The artifact detector, in a further aspect, comprises a modulation estimator configured to receive at least two band pass filtered envelope signals and configured to provide at least one normalized level of at least one band pass filtered envelope signal by dividing a level of said at least one band pass filtered envelope signal with a level of another band pass filtered envelope signal covering a lower frequency range.

The artifact detector, in a still further aspect, comprises a modulation masking estimator configured to receive at least one normalized level of a band pass filtered envelope signal, and to compare said normalized level with a modulation masking threshold level and in case said normalized level exceeds said modulation masking threshold level, determine that operation of the de-correlation unit will not result in audible artifacts in the current sound environment.

Thus according to a more general embodiment, the artifact detector is configured to determine that audible artifacts, from operation of the de-correlation unit, will not result if a modulation level of the current sound environment exceeds a modulation masking threshold level.

According to various embodiments the modulation masking threshold level is made adaptive based on at least one criteria from a group of criteria comprising: decreasing the modulation masking threshold level with increasing hearing aid processing delay, increasing the modulation masking threshold level based on a detection of the hearing aid systems users own voice, decreasing the modulation masking threshold level with increasing applied hearing aid gain, increasing the modulation masking threshold level with increasing vent size, increasing the modulation masking threshold level with an estimated increase of the sound pressure level of directly transmitted sound, and decreasing the modulation masking threshold level in response to an estimation that there is a high risk of feedback howling.

According to a further embodiment, also the threshold for when it is estimated that there is a high risk of feedback howling may be decreased. According to a more specific embodiment that may be done by first estimating that the feedback margin is low and in response hereto lower the autocorrelation threshold that according to this specific embodiment is used to estimate whether there is a high risk of feedback howling. It is noted that a low feedback margin is generally present in certain sound environment such as e.g. quiet surroundings and a user wearing a knitted hat.

According to another embodiment, the de-correlation controller is configured to select the frequency of the frequency shift to be provided by the de-correlation unit based on an evaluation of the modulation frequency spectrum of the current sound environment.

According to yet another embodiment the de-correlation unit is configured to: receive a plurality of processed residual frequency band signals, to frequency shift at least one of said plurality of processed residual frequency band signals, and to combine said plurality of processed residual frequency band signals and hereby providing the frequency shifted output transducer input signal.

According to a further embodiment the de-correlation controller is configured to select the frequency of the frequency shift to be provided by the de-correlation unit in at least one processed residual frequency band signal based on an evaluation of the modulation frequency spectrum of the current sound environment for a band pass filtered frequency band signal covering a frequency range that at least comprises part of the frequency range covered by said processed residual frequency band signal.

According to a further embodiment it is estimated that there is a high risk of feedback howling if at least one criteria is fulfilled from a group of criteria comprising: an open loop gain value exceeds an open loop gain threshold value, a feedback margin falls below a feedback margin threshold, and an autocorrelation measure of the input transducer output signal exceeds an autocorrelation threshold.

According to a second aspect, the invention comprises a method of suppressing feedback in a hearing aid system is provided that comprises the steps of: receiving an audio input signal by an acoustical-electrical input transducer, and providing an input transducer output signal; subtracting, by a first combiner, a feedback cancellation signal from the input transducer output signal and hereby generating a residual signal; processing, by a digital signal processor, the residual signal to generate a processed residual signal; receiving, by an electrical-acoustical output transducer, an output transducer input signal and to generate an acoustical output transducer output signal; receiving, by an adaptive feedback canceller, the residual signal and the output transducer input signal and to output the feedback cancellation signal; receiving the processed residual signal, by a de-correlation unit, and providing, when activated, a frequency shifted output transducer input signal, wherein at least part of the processed residual signal has been frequency shifted; determining, by an artifact detector, if the de-correlation unit, when activated, will result in audible artifacts, in a current sound environment, in the form of amplitude modulation due to mixing in the ear canal of a directly transmitted sound and the frequency shifted acoustical output transducer output signal, and activating or de-activating, by a de-correlation controller, the operation of the de-correlation unit dependent on whether the artifact detector determines that active operation of the de-correlation unit, in the current sound environment, will result in audible artifacts.

According to a third aspect, the invention comprises a computer-readable medium comprising instructions which, when executed by a computer, causes the computer to carry out the steps of the method according to the second aspect.

According to a more specific embodiment, the frequency of the applied frequency shift is determined by a narrowband modulation analysis, whereby modulation masking of the frequency shift induced audible artefacts may be ensured by selecting a frequency of the frequency shift that is estimated to be masked by the modulations of the current sound environment.

According to a more specific embodiment the frequency to be shifted can be selected from the ranges of 4-8 Hz, 8-16 Hz and 16-32 Hz dependent on the current sound environment and its ability to mask audible artefacts induced by a given frequency shift. Thus, the frequency to be shifted may be selected based on the magnitude (and hereby modulation masking capability) of the provided band pass filtered envelope signals (as provided by the envelope band pass filters).

According to a more specific embodiment the (at least one) envelope filter bank (each) comprises a first envelope band pass filter configured to provide a first band pass filtered envelope signal in the range of 0-4 Hz, and at least one additional envelope band pass filter configured to provide a band pass filtered envelope signal in the range of say 4-8 Hz, or in the range of 8-16 Hz or in the range of 16-32 Hz. However, other frequency ranges may be selected for the envelope filter band pass filters. According to a further embodiment frequency envelope band pass filters ranging up to 100 Hz may be considered.

According to another more specific embodiment at least one of the envelope band pass filters comprises a 4th order elliptic IIR filter.

The above hearing aid system, method and computer readable medium provides for improved feedback cancellation and improved sound quality.

Further advantageous features appear from the dependent claims.

Still other features of the present invention will become apparent to those skilled in the art from the following description wherein the invention will be explained in greater detail.

### 4 BRIEF DESCRIPTION OF THE DRAWINGS

By way of example, there is shown and described a preferred embodiment of this invention. As will be realized, the invention is capable of other different embodiments, and its several details are capable of modification in various, obvious aspects all without departing from the invention. Accordingly, the drawings and descriptions will be regarded as illustrative in nature and not as restrictive. In the drawings:

FIG. 1 illustrates highly schematically a hearing aid with adaptive feedback cancellation according to the prior art;

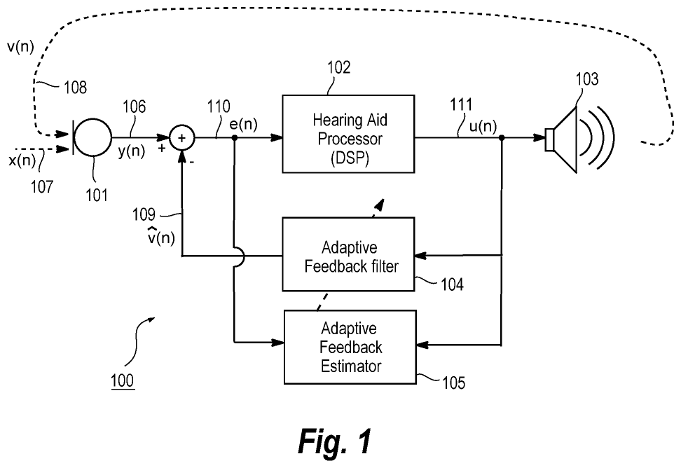

FIG. 2 illustrates highly schematically a hearing aid system according to an embodiment of the invention;

FIG. 3 illustrates highly schematically a method according to an embodiment of the invention, and

FIG. 4 illustrates highly schematically more details of a selected part of a hearing aid system according to an embodiment of the invention.

### DETAILED DESCRIPTION

In the present context the term “frequency” may be construed to mean an audio frequency, as used e.g. in the context of the frequency range of the input transducer output signal, the band pass filtered frequency band signals and the processed residual frequency band signals, but the term may also be construed to cover a modulation frequency, as used e.g. in the context of the frequency range of the envelope band pass filters and band pass filtered envelope signal. As will be obvious from the context the term may even sometimes be used to represent both.

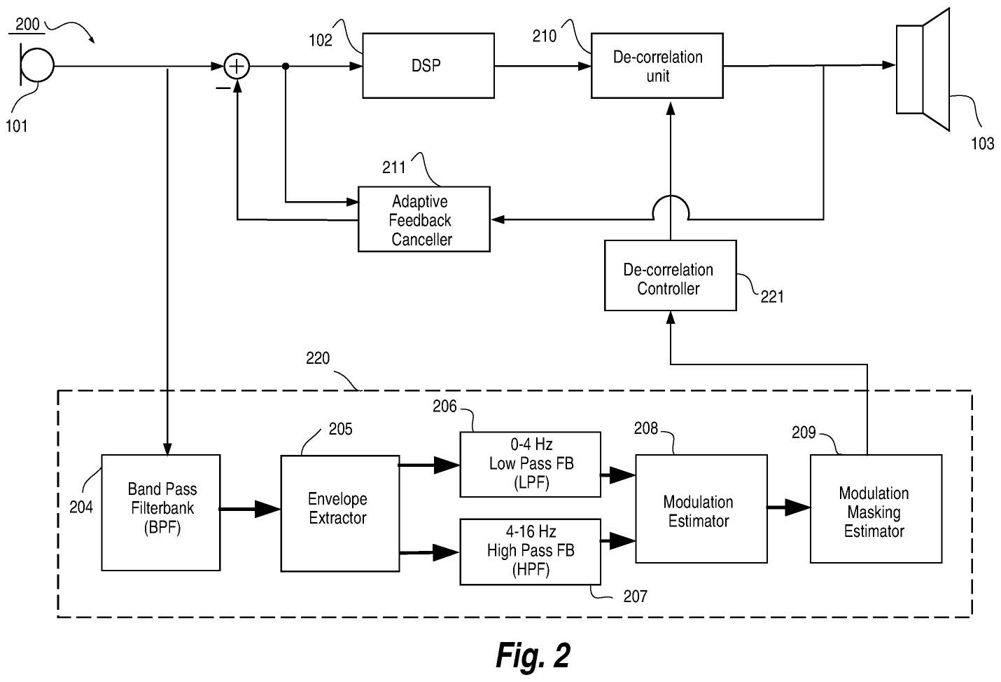

Reference is now made to FIG. 2, which illustrates, highly schematically, a hearing aid system 200 according to an embodiment of the invention. In FIG. 2 the hearing aid system 200 only consists of a single hearing aid, but in a binaural hearing aid system the two hearing aids will obviously have the same elements in order to provide the functionality of the present invention.

The hearing aid system 200 comprises an acoustical-electrical input transducer 101 that receives an audio input signal and converts this audio input signal into an input transducer output signal. The input transducer output signal is fed into a first combiner. The first combiner is configured to subtract a feedback cancellation signal from the input transducer output signal and hereby generate a residual signal. The residual signal is branched and provided both to an adaptive feedback canceller 211 and to a digital signal processor (DSP) 102 that generates a processed residual signal. The processed residual signal is received by a de-correlation unit 210 that applies a frequency shift to at least a part of the received signal if a de-correlation controller 221 has activated the de-correlation unit 210. It is noted that if the de-correlation unit 210 is not active (which in the following may also be denoted deactivated), then it is transparent and the residual processed signal will be equal to an output transducer input signal that is received by an electrical-acoustical output transducer 103 that is configured to generate an acoustical output transducer output signal based hereon.

The de-correlation unit 210 applies the frequency shift in order to at least decrease any potential correlation between the output transducer input signal and the part of the input transducer output signal without feedback in order to give the adaptive feedback canceller 211 the best conditions for adapting to the current acoustical feedback path by reducing bias. The frequency shifting is a non-linear transform which breaks the linearity of the feedback loop. This essentially improves the ability to differentiate between external sounds and a feedback component, which may also be known as reducing the bias.

According to an embodiment the de-correlation (frequency and/or phase shift) may be carried out by applying a Hilbert transformation.

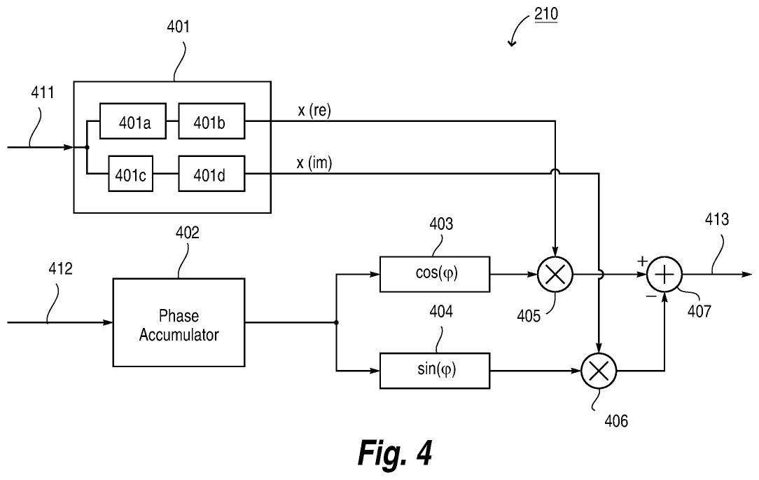

Reference is therefore now given to FIG. 4, which illustrates, highly schematically a de-correlation unit 210 according to an embodiment of the invention. The de-correlation unit 210 comprises a Hilbert transformer 401, a phase accumulator 402, a cosine function block 403, a sine function block 404, a first multiplier node 405, a second multiplier node 406 and a difference node 407. The Hilbert transformer 401 comprises a first all-pass filter 401a, a second all-pass filter 401b, a phase inverter 401c and a third all-pass filter 401d. The de-correlation unit 210 accepts as first input a source signal 411 (corresponding to the processed residual signal described above with reference to FIG. 2) and as a second input 412 the value of the frequency shift to be applied. The de-correlation unit 210 then ultimately provides the frequency shifted signal 413 (i.e. the frequency shifted processed residual signal, which in the following may also be denoted the frequency shifted output transducer input signal.

It is particularly advantageous to use the Hilbert transform for frequency shifting in a hearing aid, because the Hilbert transform can also be used for other purposes in a hearing aid such as e.g. speech detection and frequency transposition.

However, it is noted that other methods for providing a frequency shift of at least a part of a signal exists as will be well known for a person skilled in the art. Especially it is noted that a frequency shift can be applied both in the time-domain and the time-frequency domain.

As already discussed above it can be selected only to frequency shift a part of the frequency range of the processed residual signal. Using the Hilbert transform this may be carried out in a very simple manner simply by selecting the source signal 411 to only contain the desired frequency range (typically in the form of one or more frequency bands).

However, in order to determine whether the de-correlation unit 209 shall frequency shift at least a part of the processed residual signal the input transducer outputs signal is branched and also provided to a band pass filter bank (BPF) 204 which band pass filters the input transducer output signal into at least one band pass filtered frequency band signal.

Normally a plurality of band pass filtered frequency band signals is provided by BPF 204 but according to a specific variation only a single such signal is provided and as an example that single signal could cover the audible frequency range above say 1.5 kHz. Even more specifically the upper limit of the audible frequency range may be selected to be 10 kHz.

Thus according to the present embodiment said plurality of band pass filtered frequency band signals are provided to a corresponding plurality of envelope extractors 205 and for each of said signals an envelope signal is provided. Subsequently, each of said (at least one) envelope signals are provided to a corresponding number of envelope filter banks, wherein each of said comprises at least two envelope band pass filters 206 and 207.

According to a more specific embodiment at least one of the envelope filter banks comprises more than two envelope band pass filters, e.g. four envelope band pass filters covering the frequency range of 0-4 Hz, 4-8 Hz, 8-16 Hz and 16-32 Hz respectively.

Next the output signals from the at least one envelope filter bank are provided to a modulation estimator 208 which estimates determines an amount of modulation in the input transducer output signal. The modulation estimator 208 provides an estimate of the modulation frequency spectrum (for the full or a part of the frequency range of the input transducer input signal) by dividing a level of said at least one band pass filtered envelope signal with a level of another band pass filtered envelope signal covering a lower frequency range.

Thus the modulation estimator 208 provides a (normalized) modulation frequency spectrum and it is noted that the modulation frequency spectrum of the given sound environment depends on whether it is based on the full input transducer output signal or only based on a given frequency range (e.g. in the form of a frequency band) of the input transducer output signal.

According to a variation the modulation frequency spectrum estimated by the modulation estimator 208 needs not be normalized (i.e. providing normalized levels of the band pass filtered envelopes) but it is advantageous in providing a modulation spectrum that is independent on the level of the input transducer output signal.

Now the modulation frequency spectrum is provided to a modulation masking estimator 209 that compares at least one normalized level of a band pass filtered envelope signal, and with a corresponding modulation masking threshold level and in case said normalized level exceeds said modulation masking threshold level, estimates that operation of the de-correlation unit (210) to apply a frequency shift having a frequency within the frequency range of the band pass filtered envelope signal will not result in audible artifacts in the current sound environment, when the frequency shift is applied to a frequency range of the input transducer signal that corresponds to the frequency range of the band pass filtered frequency band signal that the band pass filtered envelope signal was based on.

According to the present embodiment the modulation masking estimator 209 estimates whether audible artifacts, in the form of amplitude modulation due to mixing in the ear canal of a directly transmitted sound and the frequency shifted acoustical output transducer output signal, will result in the current sound environment for the given frequency of the frequency shift within a given frequency range of the input transducer output signal.

According to an embodiment the modulation masking threshold level is determined based on listening tests. In this context it is noted that the audibility of artifacts induced by a frequency shift in a given sound environment depends on the both the frequency of the applied frequency shift but also on the audio frequency where the frequency shift is applied.

A de-correlation controller 221 is configured to activate or de-activate the de-correlation unit 210 dependent on whether an artifact detector 220 (based on the modulation masking estimator 209) determines that active operation of the de-correlation unit (210) will result in audible artifacts. As illustrated in FIG. 2 the artifact detector according to the present embodiment comprises the band pass filterbank, envelope extractor, the envelope band pass filters, a modulation estimator and a modulation masking estimator.

It is noted that if the de-correlation unit is de-activated it will be transparent such that the processed residual signal will be equal to the output transducer input signal.

Finally the output from the de-correlation unit 210 is branched and provided both to the electrical-acoustical output transducer 103 and to the adaptive feedback canceller 211, which provides a feedback cancellation signal that is subtracted from the input transducer output signal and whereby the residual signal is generated, which again is provided to the digital signal processor that is configured to provide a processed residual signal that has been processed in order to at least one of compensating a hearing loss and reducing noise.

According to an embodiment the modulation masking threshold level is configured to be adaptive based on various circumstances, whereby the threshold level allowing activating of the de-correlation unit 210 can be set to a lower value and hereby applied more often if the induced audible artefacts are less strong (i.e. the depth of the induced beats are more shallow) and vice versa.

Thus this embodiment reflects that the modulation masking threshold level initially is selected based on listening tests and consequently may not be perfect under all circumstances experienced in real life.

According to an embodiment the modulation masking threshold is configured to be adaptive based on at least one of the hearing aid processing delay, presence of the hearing aid users own voice, the applied hearing aid gain, hearing aid vent size and the sound pressure level of directly transmitted sound. The audible artifacts (i.e. the depth of the amplitude modulation due to mixing in the ear canal of the directly transmitted sound and the frequency shifted sound provided by the electrical-acoustical output transducer) are largest when the Sound Pressure Level (that in the following may be abbreviated SPL) of the mixed sounds (i.e. the interfering sounds) is of equal magnitude.

Thus by considering e.g. the vent size and the applied hearing aid gain the SPL of the directly transmitted sound and the frequency shifted sound can be estimated and based hereon the threshold value for activating frequency shifting (i.e. the modulation masking threshold) can be adapted accordingly.

According to another embodiment, the modulation masking threshold level is decreased with an increase of hearing aid processing delay because the strength of the induced amplitude modulation generally decreases with increasing hearing aid processing delay.

On the other hand a detection of own voice of a hearing aid system user should lead to an increase of the modulation masking threshold because when the user speaks the level of the directly transmitted sound will increase because the user's own voice is not just transmitted into the ear canal through the vent but is also transmitted via bone conducting. Since the level of the directly transmitted sound typically is smaller than the amplified and frequency shifted provided by the hearing aid then the modulation masking threshold should be raised in response to an own voice detection.

In a preferred embodiment, the de-correlation unit is configured to adjust a frequency of a frequency shift to be within the frequency range of the band pass filtered envelope signal with the largest normalized level, and wherein the frequency of the frequency shift in at least one processed residual frequency band signal is preferably determined based on the normalized level of a band pass filtered envelope signal for a corresponding (i.e. similar or identical) band pass filtered frequency band signal.

Thus according to an embodiment the artifact detector 220 is configured to estimate the modulation frequency spectrum (e.g. based on at least one normalized level of band pass filtered envelope signals) for each of the band pass filtered frequency band signals having a corresponding processed residual frequency band signal.

According to an embodiment the frequency of the applied frequency shift is set to a fixed value. According to a more specific embodiment the fixed value of the frequency shift to be applied is selected to be 11 Hz or in the range between 9 and 13 Hz. The inventors have found that this frequency range provides an optimum compromise between efficient de-correlation and efficient modulation masking. Generally the efficiency of the de-correlation will increase with increased frequency of the applied frequency shift, however a lower frequency of say 4 Hz has been found to be a sort of optimum for achieving modulation masking from most sound environment because the modulation spectrum for speech peaks around 4 Hz. However, on the other hand, the perceived loudness of a modulation induced by a 4 Hz frequency shift represents a sort of maximum and consequently it will generally be preferred to select another (i.e. higher) frequency shift.

According to an embodiment, the de-correlation unit 210 is configured to adjust the frequency of an applied frequency shift to be within the frequency range of the band pass filtered envelope signal; with the largest normalized level.

According to another embodiment the frequency of the frequency shift applied to a processed residual frequency band signal is preferably determined based on at least one normalized band pass filtered envelope signal level estimated for a corresponding band pass filtered frequency band signal. Thus according to a more specific embodiment the band pass filter bank 204 is positioned upstream of the branching of the input transducer output signal in order to provide a plurality of band pass filtered frequency band signals to both the artifact detector 220 and the digital signal processor 102. However according to an alternative embodiment the digital signal processor 102 can be configured to provide a band pass filter bank functionality that is at least partly the same as the band pass filter bank 204.

Thus, frequency shifting may generally provide audible artifacts. Caution should therefore preferably be made such that frequency shifting is applied only when needed. However, as already discussed it is advantageous to apply frequency shift as often as possible in order to stabilize the hearing aid and to ensure that the bias in the feedback path estimate will be reduced and by using the present invention it can be provided that frequency shifting is generally provided when it does not result in audible artifacts due to the available modulation masking from the current sound environment.

However, the inventors have realized that in some cases it may be desirable to apply a frequency shift even if an audible artifact will result. One example of such a case is when there is a (relatively) high risk of feedback howling, since a howling hearing aid system will generally be much more annoying than the audible artifacts induced by a frequency shift.

According to an embodiment the modulation masking threshold is therefore made adaptive such that the modulation masking threshold level is decreased in response to an estimation that there is a high risk of feedback howling, whereby the frequency shifting will be applied more aggressively under these circumstances. This is especially advantageous in enabling a gradually more aggressive frequency shifting compared to a solution where the frequency shift is selected to be continuously applied when a high risk of howling is detected.

According to more specific embodiments, a high risk of feedback howling may be estimated if at least one of the following criteria are fulfilled: the open loop gain value exceeds an open loop gain threshold value, the feedback margin falls below a feedback margin threshold, and an autocorrelation measure of the input transducer output signal exceeds an autocorrelation threshold.

However, according to an alternative (or additional to the above) embodiment the hearing aid system may further comprise a feedback howling detector that is configured to trigger the activation of the frequency shifting if an even higher risk of feedback howling is estimated and independent on whether a modulation level of the current sound environment exceeds a (possibly adaptive) modulation masking threshold level.

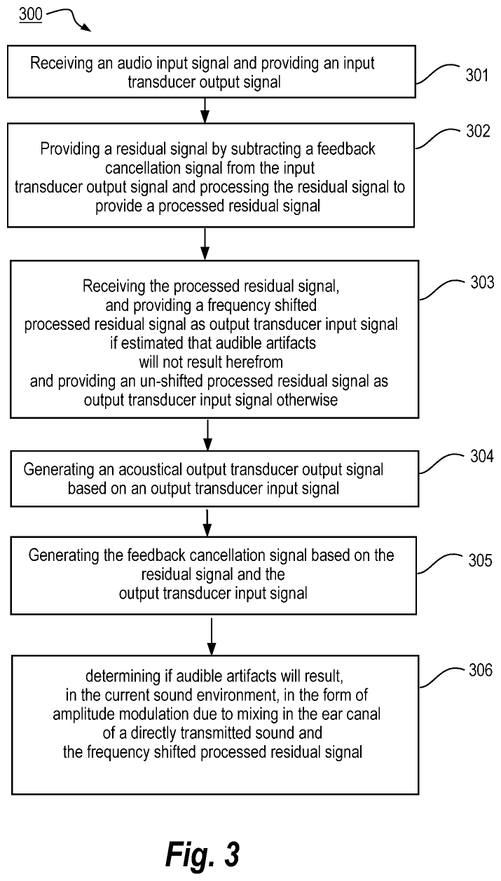

Reference is now made to FIG. 3, which illustrates highly schematically a flow diagram of a method 300 for operating a hearing aid system with adaptive feedback cancellation and configured to using modulation masking of frequency shifted input signals. The following steps of the inventive method can be carried out by the hearing aid system.

In a first step 301 of the method an audio input signal is received by an acoustical-electrical input transducer and in return provides an input transducer output signal.

In step 302, a feedback cancellation signal is subtracted by a first combiner from the input transducer output signal in order to provide a residual signal and subsequently the residual signal is processed by hearing aid signal processing means in order to generate a processed residual signal.

In step 303 a frequency shifted processed residual signal is provided as output transducer input signal, if it is estimated that no audible artifacts will result therefrom and otherwise the un-shifted processed residual signal will be provided as the output transducer input signal.

In step 304 an electrical-acoustical output transducer receives the output transducer input signal and generates in response an acoustical output transducer output signal.

In step 305, the feedback cancellation signal is generated based on the residual signal and the output transducer input signal.

In step 306, it is determined if audible artifacts will result, in the current sound environment, in the form of amplitude modulation due to mixing in the ear canal of a directly transmitted sound and the frequency shifted processed residual signal.

It is generally noted that even though many features of the present invention are disclosed in embodiments comprising other features then this does not imply that these features by necessity need to be combined.

As one example the various methods for adaptively controlling the modulation masking threshold is independent on the number of band pass filtered frequency band signals provided by the BPF 204.

As another example it is mentioned that the invention generally can be implemented both in the time domain and in the time-frequency domain.

Other modifications and variations of the structures and procedures will be evident to those skilled in the art.

1. A hearing aid system comprising:
an acoustical-electrical input transducer configured to receive an audio input signal and to output an input transducer output signal;
a first combiner, configured to subtract a feedback cancellation signal from the input transducer output signal and to hereby generate a residual signal;
a digital signal processor configured to process the residual signal to generate a processed residual signal;
an electrical-acoustical output transducer configured to receive an output transducer input signal and to generate an acoustical output transducer output signal;
an adaptive feedback canceller configured to receive the residual signal and the output transducer input signal and to provide the feedback cancellation signal;
a de-correlation unit configured to, when active, receive the processed residual signal and to frequency shift at least part of the processed residual signal and hereby provide a frequency shifted output transducer input signal
an artifact detector configured to determine if active operation of the de-correlation unit, in a current sound environment, will result in audible artifacts in the form of amplitude modulation due to mixing in the ear canal of a directly transmitted sound and the frequency shifted acoustical output transducer output signal, and
a de-correlation controller configured to activate or de-activate the de-correlation unit dependent on whether the artifact detector determines that active operation of the de-correlation unit will result in audible artifacts.

2. The system of claim 1, wherein the artifact detector further comprises a band pass filter bank configured to band pass filter the input transducer output signal into at least one band pass filtered frequency band signal.

3. The system of claim 1, wherein the artifact detector comprises at least one envelope extractor configured to receive the input transducer output signal or said at least one band pass filtered frequency band signal and configured to provide a respective temporal envelope for the input transducer output signal or for each of said at least one band pass filtered frequency band signals and hereby providing at least one envelope signal.

4. The system of claim 3, wherein the artifact detector comprises at least one envelope filter bank comprising at least two envelope band pass filters wherein each of said at least one envelope filter banks are configured to receive an envelope signal and to provide a plurality of band pass filtered envelope signals.

5. The system of claim 4, wherein at least one of said envelope filter banks comprises at least two envelope band pass filters each configured to provide band pass filtered envelope signals within a frequency range below 32 Hz or below 100 Hz.

6. The system of claim 4, wherein the artifact detector comprises a modulation estimator configured to receive at least two band pass filtered envelope signals and configured to provide at least one normalized level of at least one band pass filtered envelope signal by dividing a level of said at least one band pass filtered envelope signal with a level of another band pass filtered envelope signal covering a lower frequency range.

7. The system of claim 6, wherein the artifact detector further comprises an modulation masking estimator configured to
receive at least one normalized level of a band pass filtered envelope signal, and
compare said normalized level with a modulation masking threshold level and in case said normalized level exceeds said modulation masking threshold level, determine that operation of the de-correlation unit will not result in audible artifacts in the current sound environment.

8. The system of claim 1, wherein the artifact detector is configured to determine that audible artifacts, from operation of the de-correlation unit, will not result if a modulation level of the current sound environment exceeds a modulation masking threshold level.

9. The system of claim 7, wherein the modulation masking threshold level is made adaptive based on at least one criteria from a group of criteria comprising:
decreasing the modulation masking threshold level with increasing hearing aid processing delay,
increasing the modulation masking threshold level based on a detection of the hearing aid systems users own voice,
decreasing the modulation masking threshold level with increasing applied hearing aid gain,
increasing the modulation masking threshold level with increasing vent size,
increasing the modulation masking threshold level with an estimated increase of the sound pressure level of directly transmitted sound, and
decreasing the modulation masking threshold level in response to an estimation that there is a high risk of feedback howling.

10. The system of claim 1, wherein the de-correlation controller is configured to select a value of the frequency shift to be provided by the de-correlation unit based on an evaluation of the modulation frequency spectrum of the current sound environment.

11. The system of claim 1, wherein the de-correlation unit is configured to:
receive a plurality of processed residual frequency band signals,
to frequency shift at least one of said plurality of processed residual frequency band signals, and
to combine said plurality of processed residual frequency band signals and hereby providing the frequency shifted output transducer input signal.

12. The system of claim 11, wherein the de-correlation controller is configured to select the frequency of the frequency shift to be provided by the de-correlation unit in at least one processed residual frequency band signal based on an evaluation of the modulation frequency spectrum of the current sound environment for a band pass filtered frequency band signal covering a frequency range that at least comprises part of the frequency range covered by said processed residual frequency band signal.

13. The system according to claim 9, wherein it is estimated that there is a high risk of feedback howling if at least one criteria is fulfilled from a group of criteria comprising:
the open loop gain value exceeds an open loop gain threshold value,
the feedback margin falls below a feedback margin threshold, and
an autocorrelation measure of the input transducer output signal exceeds an autocorrelation threshold.

14. A method of operating a hearing aid system comprising:
receiving an audio input signal by an acoustical-electrical input transducer, and providing an input transducer output signal;
subtracting, by a first combiner, a feedback cancellation signal from the input transducer output signal and hereby generating a residual signal;
processing, by a digital signal processor, the residual signal to generate a processed residual signal;
receiving, by an electrical-acoustical output transducer, an output transducer input signal and to generate an acoustical output transducer output signal;
receiving, by an adaptive feedback canceller, the residual signal and the output transducer input signal and to output the feedback cancellation signal;
receiving the processed residual signal, by a de-correlation unit, and providing, when activated, a frequency shifted output transducer input signal, wherein at least part of the processed residual signal has been frequency shifted;
determining, by an artifact detector, if the de-correlation unit, when activated, will result in audible artifacts, in a current sound environment, in the form of amplitude modulation due to mixing in the ear canal of a directly transmitted sound and the frequency shifted acoustical output transducer output signal, and
activating or de-activating, by a de-correlation controller, the operation of the de-correlation unit dependent on whether the artifact detector determines that active operation of the de-correlation unit, in the current sound environment, will result in audible artifacts.

15. A computer-readable medium comprising instructions which, when executed by a computer, causes the computer to carry out the steps of the method of claim 14.
